(19) United States
(12) Patent Application Publication
(10) Pub. No.: US 2013/0262069 A1
(43) Pub. Date: Oct. 3, 2013

(54) TARGETED SITE SELECTION WITHIN SHALE GAS BASINS

(71) Applicant: Jay Edward Leonard, Superior, CO (US)

(72) Inventor: Jay Edward Leonard, Superior, CO (US)

(73) Assignee: PLATTE RIVER ASSOCIATES, INC., Boulder, CO (US)

(21) Appl. No.: 13/433,949

(22) Filed: Mar. 29, 2012

(51) Int. Cl. G06F 19/00; G06G 7/48

(52) U.S. Cl. 703/10; 702/13

(57) ABSTRACT

Targeted site selection determines the best hydrocarbon producing locations within areas of highest hydrocarbon reserves of a resource play. The best hydrocarbon production locations are selected within an area of favorable conditions for resource production based on source rock and reservoir properties. Risking of hydrocarbon production and productivity includes Monte Carlo simulations of a shale gas production model for targeted sites using probability distributions for petroleum systems model parameters, well parameters, and project parameters. Cumulative probability of recoverable hydrocarbons for the portfolio of targeted hydrocarbon production locations allows the high-grading of areas of greatest potential within the resource play.

### BACKGROUND

Currently, natural gas accounts for a quarter of U.S. energy use including heating about half of U.S. homes and accounting for approximately 20 percent of U.S. electricity production. Natural gas may also be used for powering vehicles, and is commonly used in cars, trucks, and municipal transportation throughout the United States and worldwide. Global demand for energy is estimated to increase by as much as 70 percent by 2050. Natural gas is seen as a critical piece in meeting this increase in energy demand because it burns efficiently and is relatively low in greenhouse gas emissions. For example, natural gas produces 25 percent less carbon dioxide than oil, and approximately half as much as coal per BTU of energy. Natural gas power plants are also more efficient at generating electricity, which results in carbon dioxide emissions that are up to 65 percent less per kilowatt hour than coal. Furthermore, natural gas combustion emits far less particulate matter into the atmosphere, 90 percent lower than oil, and 99 percent lower than coal combustion. Compared to coal, natural gas produces 99 percent less sulphur dioxide and zero mercury emissions. Estimates are that replacing all current electricity generation using coal with natural gas would reduce associated carbon emissions by 50%.

Recent advances in drilling methods and production of hydrocarbon resources have made the recovery of oil and gas resources economically feasible from unconventional sources once thought to be too difficult to develop. For example, these techniques have resulted in the ability to recover large amounts of natural gas from shale gas basins. Specifically, the combination of horizontal drilling and hydro-fracturing (or “fracking”) of shale deposits have resulted in the ability to recover natural gas from shale gas basins once thought to be uneconomical source rock layers. These techniques have shown that production from shale gas basins can be economically feasible and can result in an increase of 10 to 1,000 or more times the amount of natural gas recovered per day from well sites in shale gas basins.

The realized and potential resources within shale gas basins are changing the energy landscape for natural gas. For example, the Marcellus shale in the Northeast United States alone is thought to hold between 50 trillion cubic feet (TCF) and 500 TCF of natural gas, potentially more than all but the largest natural gas fields in the Persian Gulf Estimates of total technically recoverable natural gas resources in the United States range from approximately 2,000 to approximately 2,500 TCF. These resources would provide approximately 100 years of supply for U.S. natural gas needs.

Because of the boom in natural gas production from unconventional sources such as shale deposits, coalbed methane, sandstone, and methane hydrates, the price of natural gas has declined. For example, the wellhead price has declined from a high of approximately $11 per thousand cubic feet (“MCF”) in the middle of 2008 to approximately $4 in early 2011. At the same time, the costs associated with drilling natural gas wells have increased. Therefore, accurate prediction of well production prior to drilling has increased in importance. Accordingly, successfully grading a shale gas play and targeting well sites to the most productive areas within the play is important to economically viable hydrocarbon production from the play.

Traditional shale gas resource play scope has involved disparate geological, geophysical, and/or reservoir engineering techniques. For example, geological data parameters may be generated at locations within a basin to indicate sites that may produce adequate hydrocarbons for production. Geophysical data such as seismic and log analysis may be analyzed to produce information relevant to resource production. Engineering analysis typically includes well simulation models of production based on known and estimated geological, geophysical and well parameters. Results from these disparate analyses are then aggregated based on knowledge of favorable parameter ranges and uncertainty may be estimated to provide a predicted production range.

### SUMMARY

Embodiments of the present invention are generally directed to exploration and production of hydrocarbons, including targeted site selection within areas of highest hydrocarbon reserves of a resource play. Embodiments combine basin and petroleum systems maps, common risk segment maps, and Monte Carlo risking of production and/or productivity to indicate “sweet spots within sweet spots”—the most productive areas within the areas of highest reserve estimates.

Disclosed herein is a method that includes identifying a targeted reserves region for producing oil and/or gas, based on one or more parameters relating to a source rock associated with the oil and/or gas and/or relating to a reservoir associated with the oil and/or gas; selecting one or more targeted well sites within the targeted reserves region based on uncertainty associated with parameters that are related to oil and gas potential; and modeling well production for one or more of the targeted well sites based on one or more of the source rock parameters, reservoir parameters, or oil and gas potential parameters.

The method may further include calculating a cumulative probability of a well production parameter for the one or more targeted well sites based on aggregated results from iterative simulations of a well production simulation model, wherein at least one simulation input parameter to the well production simulation model is varied over the iterative simulations based on an input probability distribution. At least one factor of the input probability distribution for the at least one simulation input parameter may be generated using a petroleum systems model.

The at least one factor of the input probability distribution for the at least one simulation input parameter may include a most likely value of the at least one simulation input parameter at the targeted well site. The at least one simulation input parameter may be based at least in part on a calculation of methane adsorption potential for the basin. At least one factor of the input probability distribution for the at least one simulation input parameter may be specific to one of the one or more targeted well sites.

The method may further include calculating a cumulative probability of a net present value parameter of a shale gas well portfolio including the one or more targeted well sites by aggregating results from iterative well portfolio simulations, wherein at least one portfolio input parameter of the iterative well portfolio simulations is varied according to a well production probability distribution generated from the iterative simulations of the well production simulation model. Well production data from a producing well in the shale gas well portfolio may be compared to a well production simulation of the producing well, and wherein at least one simulation input parameter of the iterative well production simulations is modified based on a result of the comparison.

The at least one simulation input parameter may be selected based on a rank correlation between the simulation input parameter and a well production parameter output of the shale gas production model. The method may further include calculating a cumulative probability of a well production parameter across a geographical portfolio region based on the calculated cumulative probability of the well production parameter for a plurality of the targeted well sites.

The identifying and selecting may include generating a plurality of common risk segment maps for an identified hydrocarbon basin, each common risk segment map indicating an estimated risk for a hydrocarbon production factor by geographical location within the identified hydrocarbon basin; and generating a composite common risk segment map based on the plurality of common risk segment maps, the composite common risk segment map indicating a targeted reserves region for which one or more of the plurality of common risk segment maps indicates a risk profile with lower than a predetermined risk. At least one of the common risk segment maps may include a map of a generated gas property, the generated gas property based on a kinetic modeling process. At least one of the common risk segment maps may include a map of adsorbed gas, and wherein the map of adsorbed gas is calculated based on a Langmuir analysis.

Also disclosed is a method for identifying an economically viable geographic area for shale gas production within a basin. The method includes calculating a total organic content of source rock within the basin by geographical location; determining a type of organic matter present in the source rock within the basin by geographical location; calculating a thermal maturity of organic matter within the basin by geographical location; and calculating a graded effectiveness of source rock within the basin by geographical location based on the total organic content, the organic matter type, and the thermal maturity of the organic matter within the basin.

Calculating the total organic content may include calculating an organic rich interval of source rock. Calculating the organic rich interval of source rock within the basin may be based at least in part on a sequence stratigraphy of the basin. Calculating the organic rich interval of source rock within the basin may be based at least in part on identification of a transgressive systems tract using sequence stratigraphy. The identified transgressive systems tract may be correlated to a measured organically rich interval.

Also disclosed is a method including calculating at least one source rock composition property over a geographic area; calculating at least one reservoir porosity property of a hydrocarbon basin by geographic location; calculating at least one reservoir pressure property of a hydrocarbon basin by geographic location; and generating a reservoir effectiveness map based on the at least one source rock property, the at least one hydrocarbon flow property, and the at least one reservoir pressure property, the reservoir effectiveness map indicating areas of favorable reservoir production performance over the geographic area.

The at least one reservoir porosity property may be based at least in part on a nanoporosity parameter associated with degradation of organic carbon within the basin. The at least one reservoir pressure property may be based at least in part on a reservoir pressure component associated with uplift of source rock in the geographic area. The at least one reservoir pressure property may be based at least in part on a calculated generation pressure associated with conversion of organic matter to hydrocarbons within the reservoir. Reservoir pressure may be based on at least one of the following reservoir pressure components: mechanical compaction, chemical compaction, generation pressure, and/or pressure associated with the development of nanoporosity due to degradation of organic carbon and gas expansion within the nanoporosity due to uplift of the source rock.

### BRIEF DESCRIPTION OF THE DRAWINGS

Embodiments of the present invention are illustrated in referenced figures of the drawings, in which like numbers refer to like elements throughout the description of the figures.

FIG. 1 illustrates a process flow for targeted site selection within a hydrocarbon resource basin, according to various embodiments.

FIG. 2 illustrates a process flow for calculating initial total organic content of a resource play, according to various embodiments.

FIG. 3 illustrates a process flow that may be used to determine thickness of an organic rich source rock interval of a resource play, according to various embodiments.

FIG. 4 illustrates how sequence stratigraphy may be combined with calculated and/or measured total organic content data to determine an organic rich interval of source rock, according to various embodiments.

FIG. 5 illustrates process flow that may be employed to determine organic matter type from parameters associated with the geological environment, according to various embodiments.

FIG. 6 illustrates aspects of maturity determination of source rock, according to various embodiments.

FIG. 7 illustrates a process flow that may be employed to determine and plot an organic rich interval of source rock, according to various embodiments.

FIG. 8 illustrates a process flow for determining various lithologic properties of a hydrocarbon reservoir, according to various embodiments.

FIG. 9 illustrates calculation and analysis of reservoir porosity of a hydrocarbon resource play, according to various embodiments.

FIG. 10 illustrates process flow that may be used to calculate reservoir pressure, according to various embodiments.

FIG. 11 illustrates a process flow that may be employed to determine and plot reservoir effectiveness for hydrocarbon production, according to various embodiments.

FIG. 12 illustrates a process flow that may be employed to create common risk segment maps of a hydrocarbon resource play, according to various embodiments.

FIG. 13 illustrates calculation of adsorbed methane in a shale gas basin, according to various embodiments.

FIG. 14a illustrates Langmuir isotherm curves for adsorption potential vs. Pressure, according to various embodiments

FIG. 14b illustrates Langmuir isotherm curves for adsorption potential vs. Pressure at various levels of total organic content, according to various embodiments.

FIG. 14c illustrates a user interface associated with inputting data into a Methane Adsorption model.

FIG. 14d illustrates a map of Methane Adsorption in one set of units.

FIG. 14e illustrates a map of Methane Adsorption in another set of units.

FIG. 15 illustrates evaluation of four different hydrocarbon generation parameters across resource play trend or fairway using four different common risk segment maps, according to various embodiments.

FIG. 16 illustrates a composite common risk segment map that combines uncertainty for multiple layers from the four different common risk segment maps of FIG. 15 to derive spatial uncertainty for the area of evaluation, according to various embodiments.

FIG. 17 illustrates a user interface associated with inputting data into a Shale Gas Production model.

FIG. 18 illustrates a process flow for calculating uncertainty in production values of a target well site using petroleum systems modeling and reservoir simulation, according to various embodiments.

FIG. 19 shows an example of an output probability distribution of a well production parameter, according to various embodiments.

FIG. 20 illustrates a plot of probable reserves or “P50” for a favorable resource production area within a resource play scope, according to various embodiments.

FIG. 21 illustrates process flow that may be used to generate production estimates of a well portfolio of targeted sites within a resource play accounting for economic factors, according to various embodiments.

### DETAILED DESCRIPTION

The present disclosure is generally related to determining areas of most favorable hydrocarbon productivity within areas of highest hydrocarbon reserves of a shale gas play using a combination of exploration, probabilistic analysis, engineering, and uncertainty techniques. More particularly, targeted sites are selected within areas of highest hydrocarbon reserves using a combination of basin and petroleum system maps, common risk segment maps, and probabilistic risk analysis of production and/or productivity. Various techniques for determining effectiveness of source rock and/or reservoir properties are disclosed. In embodiments, the shale gas play fairway may be evaluated by using petroleum systems modeling to generate composite common risk segment (“CRS”) maps. Summary or composite CRS maps indicate “sweet spots” within the shale gas play where favorable conditions exist for all play elements. Petroleum systems modeling, uncertainty modeling, production calculations, and economic factors may be combined to identify the locations of “sweet spots within sweet spots”—the areas of best production within the areas of highest reserve estimates.

While the present disclosure is generally provided within the context of hydrocarbon exploration techniques with regard to shale gas plays, various aspects of the disclosure may be used in other types of natural resource exploration and production. Accordingly, the present disclosure is not intended to be limited to exploration and production of shale gas unless otherwise specified.

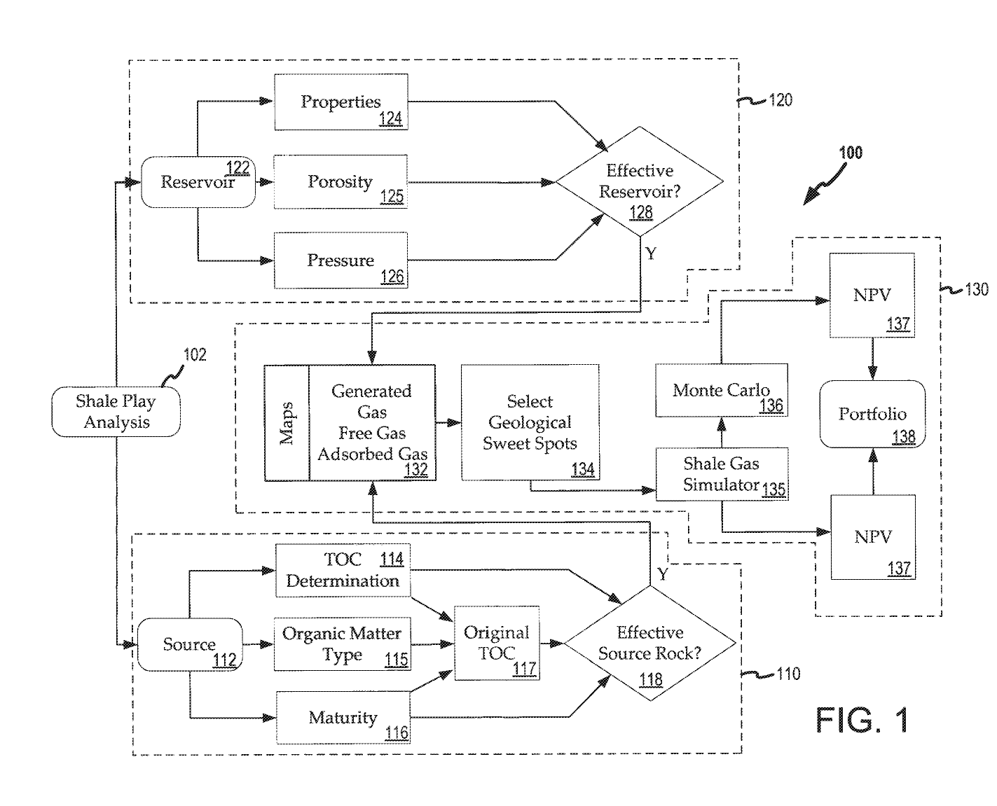

FIG. 1 illustrates a process flow 100 for targeted site selection within a hydrocarbon resource basin, according to various embodiments. Process flow 100 generally begins at block 102 with shale play analysis and typically includes three sub-processes: a reservoir analysis sub-process 120 for determining the effectiveness of hydrocarbon reservoir properties within the basin, a source rock evaluation sub-process 110 used for determining the effectiveness of source rock within the basin, and a petroleum systems modeling and simulation process 130 that combines petroleum systems modeling, uncertainty modeling, production calculations, and economic factors to provide probabilistic analysis of net present value for a targeted well portfolio within the basin. In various embodiments, one or more of these sub-processes may be used independently to provide analysis of specific aspects within the hydrocarbon resource play.

The source rock evaluation sub process 110 is generally used to determine how much hydrocarbon the source rock within the basin will generate. Source rock evaluation sub-process 110 begins at block 112 where various source rock properties are identified and evaluated to determine the overall effectiveness of the source rock in generating hydrocarbons. More particularly, sub-process 110 may include evaluating total organic carbon (“TOC”) of the source rock at block 114. Total organic carbon is a measure of the richness of the source rock, and governs how much hydrocarbon can be generated. Evaluation of total organic carbon at block 114 may involve a series of steps that determine if the source rock is rich enough to generate sufficient hydrocarbons. For example, a threshold value of 2% TOC may be considered to be a minimum amount of organic matter necessary to result in an economically successful play. In addition, this series of steps may identify locations to take samples for analysis.

Total organic carbon may be measured and/or calculated. For example, TOC may be sampled from a core or from cuttings. TOC may be sampled vertically through the source rock interval, and as much spatial variability of the play is sampled as possible (i.e., from different wells/locations). TOC may also be calculated from logs (e.g., from a combination of measured porosity (density and/or sonic) and resistivity) using various methods (e.g., Delta log R method, etc.).

At block 115, the organic matter type of the source rock may be evaluated. Organic matter type of the source rock governs how much and what type (e.g., oil, gas, and the like) of hydrocarbon can be generated. Organic matter type may be calculated from measured data produced from Rock Eval Pyrolysis, and/or visual Kerogen analysis. In the absence of measured data, depositional environments can be used to determine Kerogen type present in the source rock.

Sub-process 110 includes evaluation of source rock maturity at block 116. Thermal maturity is a function of the max temperature of source rock and the time the source rock is been exposed to that temperature. A certain level of maturity is necessary for the generation of hydrocarbons. Thermal maturity may be calculated from various source rock data measurements, as described in more detail below.

In embodiments, source rock evaluation sub-process 110 includes calculation of original TOC at block 117. Original TOC indicates the amount of organic material present at the time of source rock deposition. The difference between original (or initial) TOC and measured present-day TOC accounts for organic carbon lost during hydrocarbon generation and expulsion.

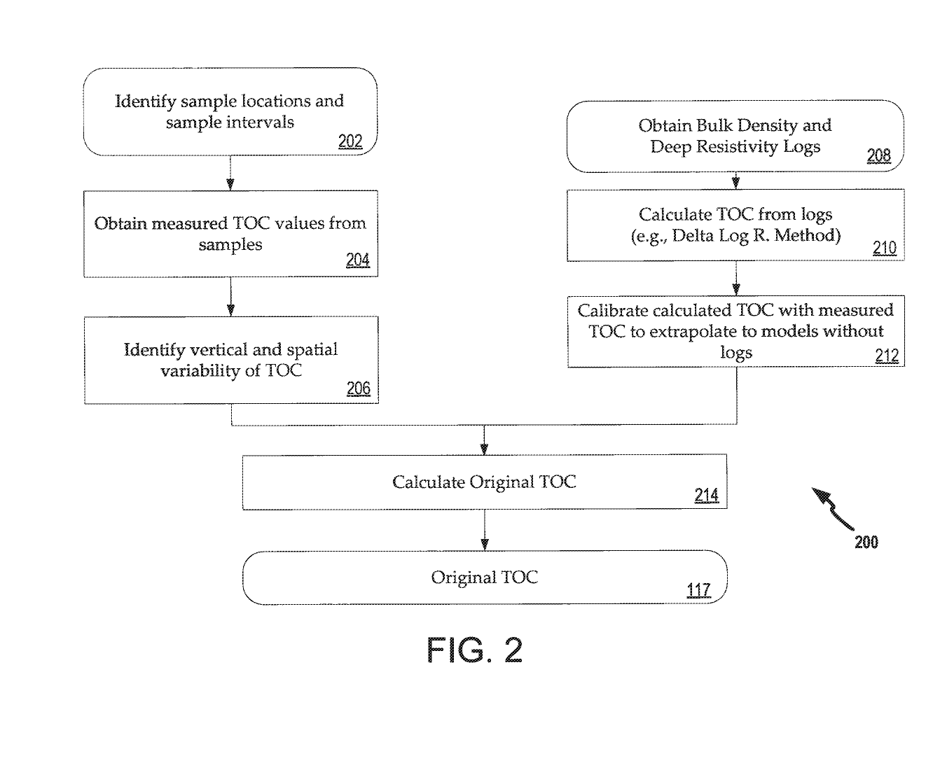

FIG. 2 illustrates a process flow 200 for combining measured TOC and calculated TOC to determine original TOC, according to various embodiments. That is, process flow 200 combines data produced through core sampling and laboratory testing with data produced through various well logging techniques. This determination may include identifying an interval which shows a higher concentration of organic material as indicated by block 202. Determining measured TOC may also include performing laboratory analysis at sample points within the interval as indicated by block 204. At block 206 of process flow 200, vertical and special variability of TOC may be measured. For example, core samples and/or cutting samples may be analyzed. In preferred embodiments, core samples are analyzed to determine how the amount of organic matter varies with depth. As can be appreciated, these three steps include getting samples to describe distribution of present day TOC.

Generally, blocks 208 and 210 include receiving and analyzing well log data from new or existing boreholes. For example well logs that may be used include wireline logs including bulk density, deep resistivity, gamma ray logs, and the like. TOC may be calculated from the various wireline logs using various techniques (e.g., Delta log R method, etc.). At block 212, the calculated TOC may be calibrated with the measured TOC from blocks 202, 204, and/or 206 to extrapolate to models without logs. As can be appreciated, these three steps (208, 210, and 212) include calculating present day TOC from logs and calibrating log TOC values with measured TOC values.

At block 214, original (i.e., initial) TOC is calculated from the measured and calculated TOC data. This is performed using the maturity as shown in block 116 of FIG. 1. Original TOC takes into account the loss of TOC over time due to generation of hydrocarbons. That is, the measured TOC at the present time is less than the original TOC. If this loss is not taken into account, the volume of generated hydrocarbons may be underestimated. The original TOC calculated using process flow 200 may be used in subsequent hydrocarbon volume calculations. Original TOC may be calculated from measured TOC (TOCmeas) according to the formula:

$${TOC}_{init = \frac{{TOC}_{meas}}{1 - ( TR \cdot Δ C )}}$$

Where TR is the transformation ratio (which accounts for thermal maturity) and ΔC is the change in carbon due to generation of hydrocarbons over time.

As described above, organic matter may vary with depth. If the entire thickness of the source information is considered to be the source rock, the result would be an over estimation of the amount of hydrocarbons generated. Accordingly, determining that portion of the source rock which is organic rich provides a more accurate estimation of generated hydrocarbons in the basin. In embodiments, sequence stratigraphy analysis can be used to assist in identifying the organic rich interval of the source rock.

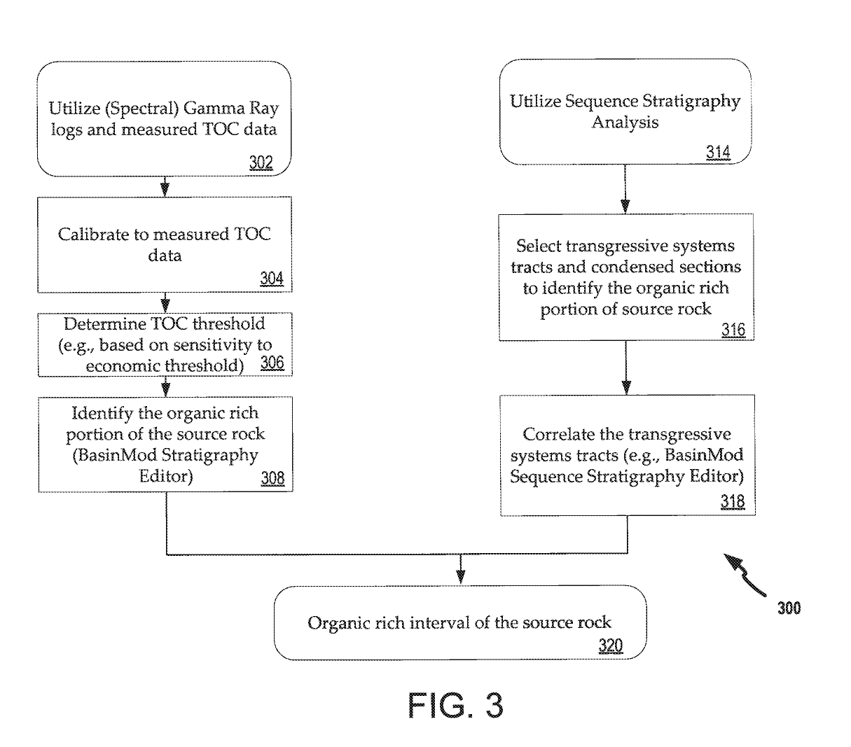

FIG. 3 illustrates a process flow 300 that may be used to determine thickness of the organic rich source rock interval using logs and/or sequence stratigraphy, according to various embodiments. Process flow 300 may be split into two main components. In the first component represented by blocks 302, 304, 306, and 308, gamma ray logs and measured TOC data may be compared against TOC thresholds. For example a TOC threshold of 2% may be used. This threshold could be adjusted depending on the thickness of the organic rich interval and the lithologic properties of the source rock. At block 306, the measured and calculated TOC data may be calibrated. For example, the calibrated TOC data may be used to provide stratigraphic information identifying the organic rich portion of the source rock at block 308.

In embodiments, the second component of process flow 300 uses sequence stratigraphy to assist in identifying the organic rich interval. That is, predominant sequence stratigraphic surfaces (e.g., maximum flooding surfaces, transgressive systems tracts, condensed sections, etc.) are used to correlate the measured data with geologic strata and timeline information. The second component may use previously prepared sequence stratigraphy analysis or it may include preparing the sequence stratigraphy information for identification of the organic rich interval. More particularly, a sequence stratigraphy analysis may be performed from geologic data at block 314. At block 316, transgressive systems tracts and condensed sections (which usually have a higher TOC) may be selected to identify the organic rich portion of the source rock. At block 318, a sequence stratigraphy editor is used to correlate the transgressive systems tracts. That is, sequence stratigraphy may be used to identify transgressive systems tracts (e.g., using condensed sections and/or maximum flooding surfaces), and these tracts are correlated with calculated and/or measured TOC data. These steps result in determining the organic rich interval of the source rock at block 320. As an alternative to steps 314 and 316, previously prepared sequence stratigraphy analysis of the basin may be analyzed and condensed sections that may have been pre-identified in the sequence stratigraphy may be selected.

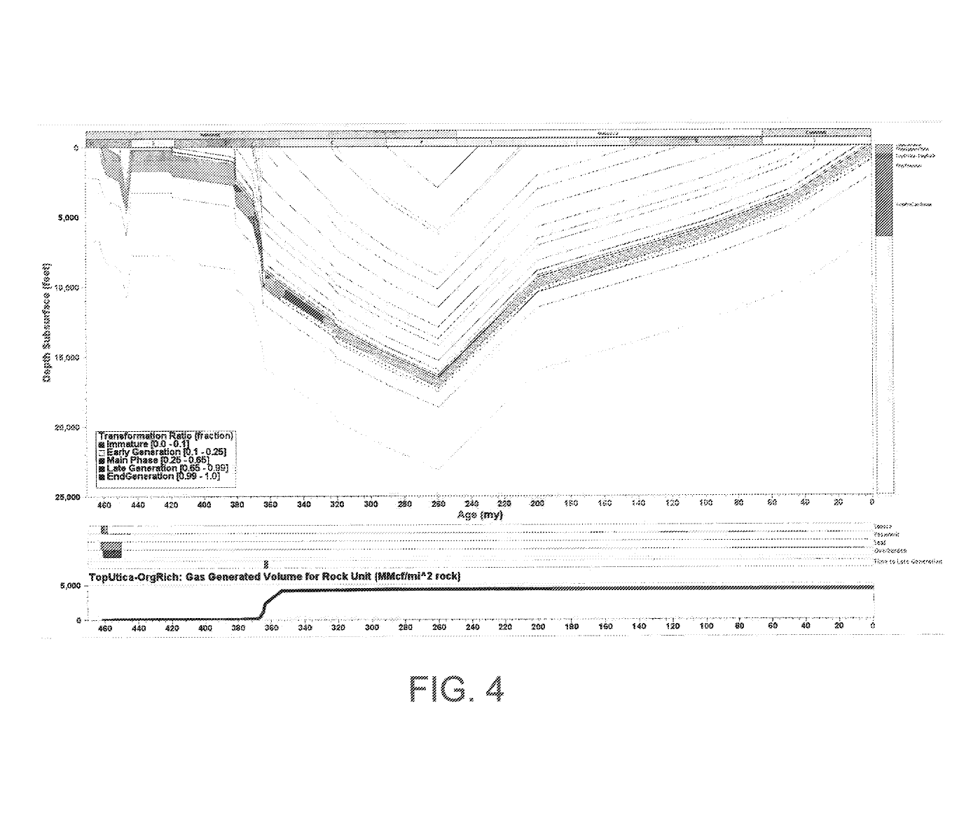

FIG. 4 is a Petroleum Systems plot showing the Burial History and Gas Generation for one of the source rocks.

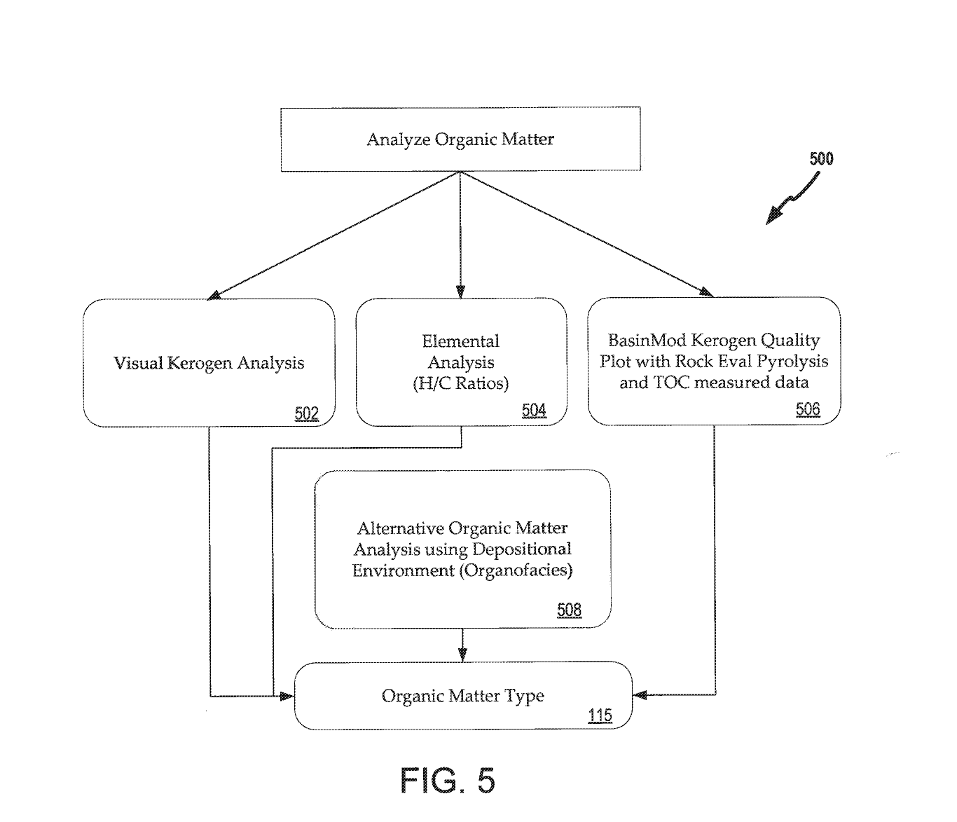

Returning to FIG. 1, the type of organic matter present in the source rock, as illustrated by block 115, is a factor in how much oil and/or gases generated and when it is generated. For this reason, an understanding of the geological environment in which the source rock was deposited is desirable. FIG. 5 illustrates process flow 500 that may be employed to determine organic matter type from parameters associated with the geological environment, according to various embodiments. As illustrated by process flow 500, organic matter type of the source rock may be determined by one or more of several different techniques. In one technique, measurements from Rock Eval Pyrolysis and TOC data are cross plotted at block 506 to generate a S₂ versus TOC, or kerogen quality, plot across the basin. The cross plot reveals source rock characteristics such as hydrocarbon proneness and organic matter type. Alternate techniques include visual kerogen analysis as illustrated by block 502 and elemental analysis at block 504. If the specific organic matter type is unknown, but the environment of deposition can be deduced, gross depositional environments (e.g., organofacies, etc.) may be used to determine organic matter type at block 508.

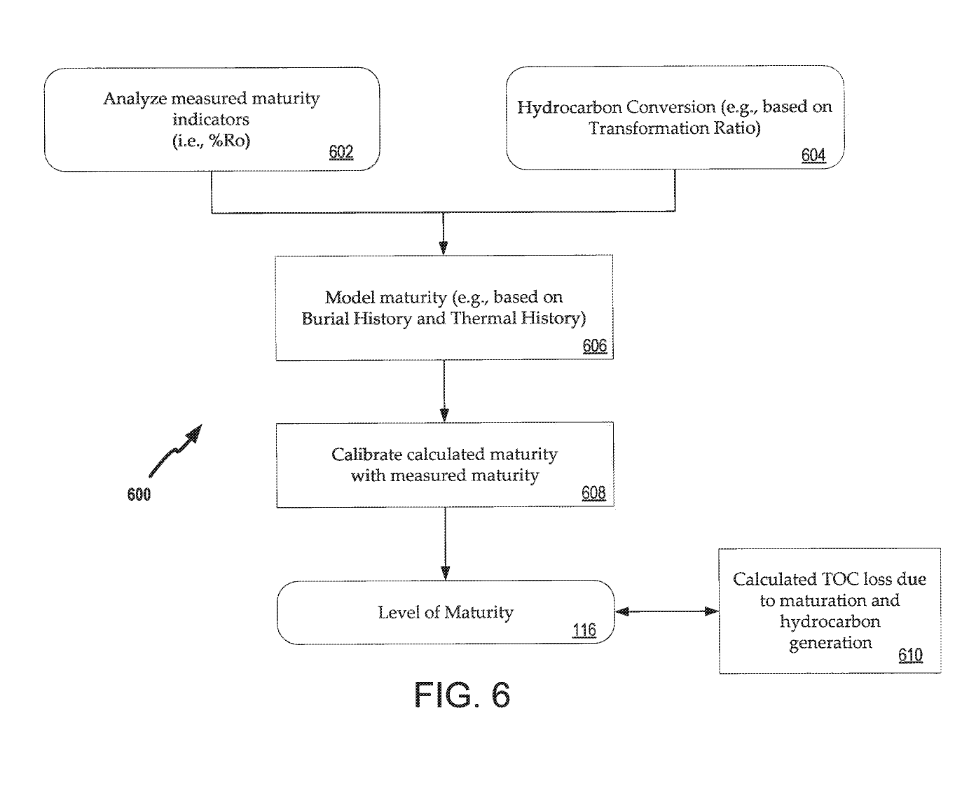

Thermal maturation is the series of physical and chemical changes that affect organic matter during burial and heating, and can result in the generation of hydrocarbons. Maturation is primarily a function of the maximum temperature of the sediment and the time of exposure of the sediment to that temperature. Maturity determination, illustrated at block 116 of process flow 100, is typically performed during petroleum systems analysis. FIG. 6 illustrates aspects of maturity determination in more detail, according to various embodiments. Specifically, process flow 600, illustrated in FIG. 6, includes analyzing measured maturity indicators at block 602 and/or determining hydrocarbon conversion at block 604. For example, the physical effects of thermal maturity can be observed and measured at block 602 using a variety of maturity indicators (e.g., Vitrinite Reflectance, Thermal Alteration index, Rock-Eval TMax, Hydrogen Index, etc.) on certain aspects of the source rock. The analyzed maturity indicators and hydrocarbon conversion properties may be used to model maturity of the source rock at block 606 (e.g., based on burial history, thermal history, and the like). The calculated maturity may be calibrated at block 608 with measured maturity (e.g., maturity indicators analyzed at block 602). Block 610 illustrates that level of maturity 116 may be used to determine calculated TOC loss due to maturation and hydrocarbon generation.

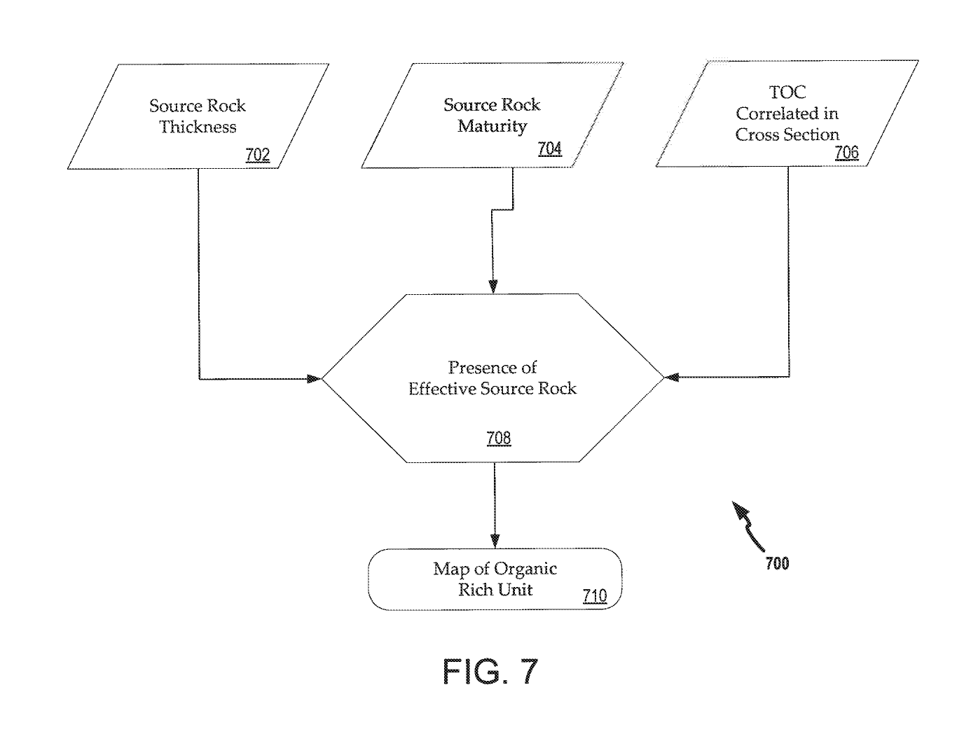

The presence of effective source rock may be determined by combining information from the sub-flows related to source rock properties described above. FIG. 7 illustrates a process flow 700 that may be employed to determine and plot the organic rich portion of the source rock, according to various embodiments. In one embodiment, a map of source rock thickness is generated at block 702. A map of maturity based on the maximum temperature of the source rock and the time that the source rock has been exposed to that temperature is generated at block 704. The presence and amount of TOC of the source rock (source rock richness) is displayed along the vertical plane for the area of interest at block 706. Overlaying the three criteria in block 708 provides a map of the organic rich unit 710 which includes the extent of the source rock which has been identified to be adequately rich, thick, and mature to produce hydrocarbons of a sufficient quantity so as to be economic.

Returning to FIG. 1, source rock evaluation sub process 110 provides the information needed to determine the effectiveness of the source rock at block 118. For example, the value of the organic rich unit provided by block 710 may be used to provide a Yes/No determination for that portion of the resource play that is adequately rich, thick, and mature to be potentially favorable to hydrocarbon generation.

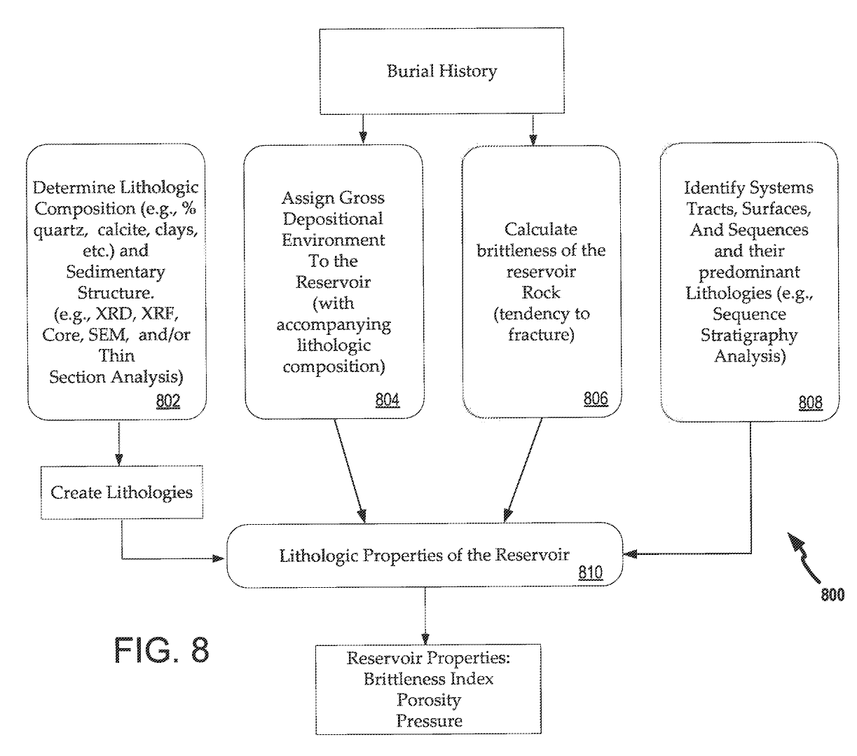

In process flow 100, reservoir analysis sub-process 120 is used to determine a reservoir formation's ability to contain hydrocarbons in terms of lithologic properties, its porosity and permeability, and the pressure within the formation. Specifically, reservoir rock analysis is conducted in various embodiments to determine the physical properties of the reservoir rock. While source rock analysis sub-process 110 was described before the description of reservoir analysis sub-process 120, either sub-process could be performed first just as they could be performed simultaneously. In one embodiment, the reservoir analysis may take place before the source rock analysis. FIG. 8 illustrates a process flow 800 for determining the lithologic properties of the reservoir 810 and determining a brittleness index.

The lithologic properties determined in process 800 include rock composition, brittleness of the reservoir, and sequence stratigraphy factors. At block 802, rock composition (lithology composition data) is determined. For example, x-ray diffraction (“XRD”), x-ray fluorescence (“XRF”), core, scanning electron microscope (SEM) and/or thin section analysis may be used to determine rock composition and/or sedimentary structure. This lithology composition data is then used to create lithological mixes (e.g., percentage of shale, silt, or limestone) or mineral mixes (e.g., percentage of clay, feldspar, quartz, or calcite). Typically, higher percentages of quartz and/or calcite and lower percentages of clay result in more brittle shales which are more prone to fracture. At block 804, gross depositional environments may be used if the specific rock type is unknown, but the environment of deposition can be deduced. At block 806, brittleness of the reservoir can be calculated, mapped, and used to determine the fracability of the reservoir. The calculation may be made from lithology based on the percentage of brittle versus ductile rocks or minerals. Brittleness can also be calculated from sonic well logs. Application of sequence stratigraphy at block 808 can identify systems, tracts, surfaces, and sequences and their predominant lithologies. One or more of these techniques are combined at block 810 to determine lithologic properties of the reservoir.

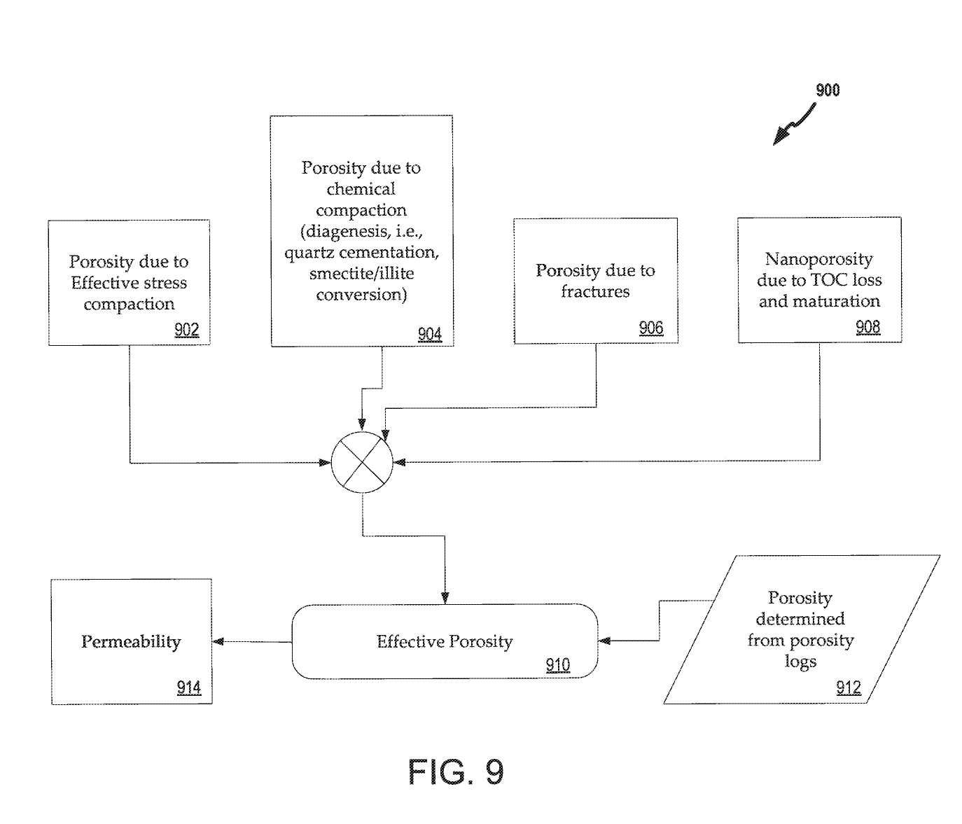

Another parameter that may be determined in reservoir analysis sub-process 120 is reservoir porosity. FIG. 9 illustrates calculation and analysis of reservoir porosity of a hydrocarbon resource play, according to various embodiments. Reservoir porosity affects hydrocarbon production because it is related to the amount of pore space which is available to hold hydrocarbons. As illustrated in process flow 900 of FIG. 9, porosity reduction occurs in a number of ways, which all contribute to the effective porosity of the reservoir. At block 902, porosity reduction may be calculated by effective stress compaction (compaction due to pressure). At block 904, porosity due to chemical compaction may be determined. This factor of porosity reduction may be due to the precipitation of quartz or the conversion of other minerals. Porosity due to fractures may be accounted for at block 906. At block 908, nanoporosity due to the degradation of organic carbon and maturation may be calculated. Initial TOC and present-day TOC are typically reported in percent by weight. By converting TOC numbers to percent by volume, the volume represented by the lost TOC is used to model nanoporosity. Nanoporosity takes into account that, as the organic matter is transformed into hydrocarbon, it creates pore space, often interconnected. Sometimes nanoporosity does contribute to the total porosity measured in porosity well logs but nanoporosity cannot always be measured by conventional porosity logs due to its microscale. At block 914, permeability may be calculated from porosity, and represents the interconnectivity between pore spaces.

In embodiments, reservoir pressure 126 is also analyzed in reservoir analysis sub-process 120. Reservoir pressure depends on the rate of sedimentation and the composition of the sediments. Reservoir pressure can be normal, or, for a variety of reasons, can be greater than normal (i.e., overpressured). Overpressured reservoirs typically have greater initial potential and higher production. Reservoir pressure affects porosity and contributes to faulting and fractures. That is, during periods of maximum hydrocarbon generation the high reservoir pressure may cause fracturing of the source rock. However, fractures may also be caused by tectonic forces. Accordingly, the type of fracturing may be analyzed and fed back into the reservoir lithologic analysis. Overpressure is modeled and a prediction is made when the pressure, whether due to compaction and/or generation pressure, may reach a fracture threshold (i.e., that pressure which would cause the rock to fracture and form a natural fracture system).

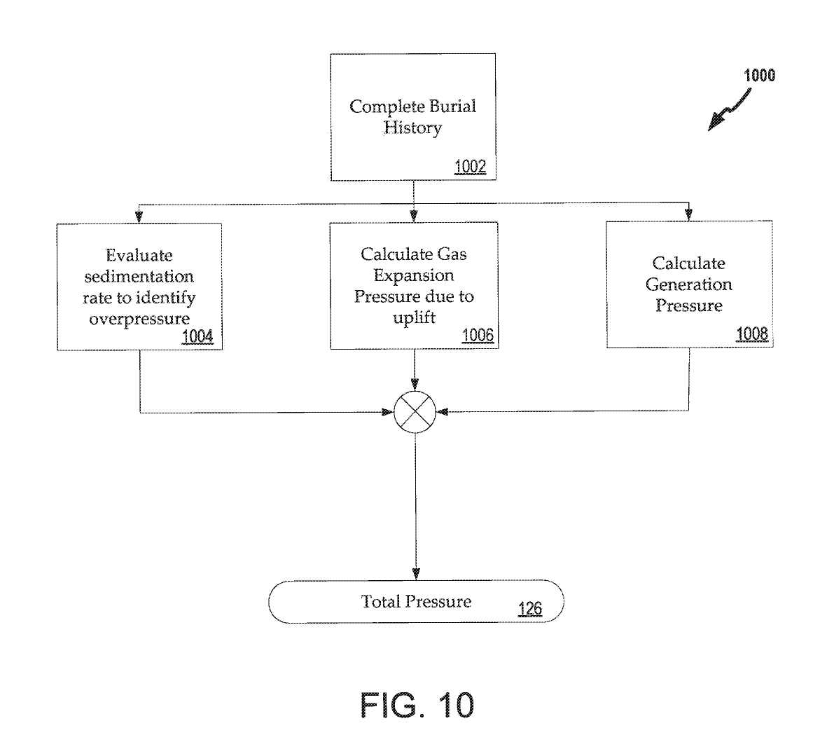

Pressure has several components, including effective stress due to compaction, generation pressure, and gas expansion pressure. FIG. 10 illustrates process flow 1000 that may be used to calculate pressure 126, according to various embodiments. Process flow 1000 starts with a burial history 1002 that summarizes when, how much, and how quickly sediment is deposited and eroded. At block 1004, areas of overpressure may be identified by evaluating sedimentation rate. At block 1006, gas expansion pressure due to uplift may be calculated. If a source rock is uplifted to a shallower depth, the pressure on the sediment decreases and the gas in the pore spaces expands. At block 1008, generation pressure may be calculated. Generation pressure is the pressure that results from the volume increase during the conversion of organic matter to hydrocarbons.

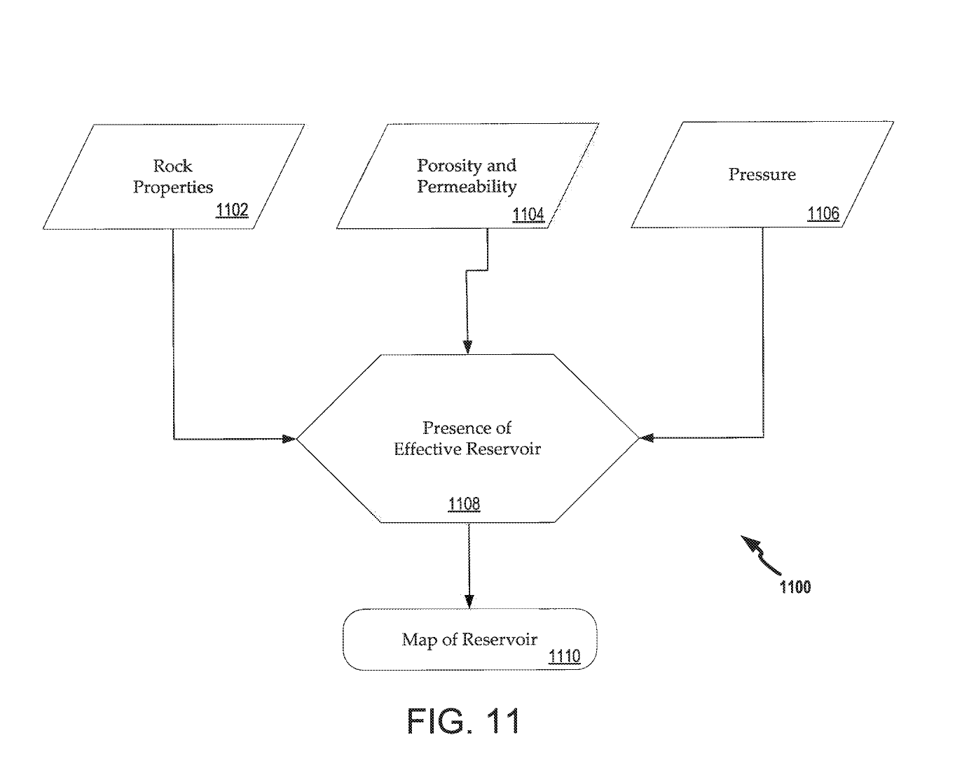

The effectiveness of the reservoir may be determined by combining information from the sub-flows related to reservoir properties described above. FIG. 11 illustrates a process flow 1100 that may be employed to determine and plot the reservoir effectiveness, according to various embodiments. In process flow 1100, rock properties 1102 (brittleness, etc.), porosity (e.g., nanoporosity due to the degradation of organic matter, etc.) 1104, and pressure (e.g., the increase of pressure due to hydrocarbon generation, the decrease in pressure due to uplift of the source rock, etc.) 1106 are combined at block 1108 to provide a map of reservoir effectiveness 1110.

Referring back to FIG. 1, reservoir effectiveness 128 identifies basins that are favorable to hydrocarbon production. For example, process flow 1100 may be used to identify basins for further analysis. More particularly, the map of reservoir effectiveness produced at block 1110 may be used to identify those areas within the resource play scope that are favorable to hydrocarbon production. When the source rock effectiveness 118 and reservoir effectiveness 128 show that the basin may have favorable areas for resource generation and production, sub-process 130 may be used to select targeted sites within the favorable areas and estimate production of a portfolio of targeted sites.

Petroleum systems modeling and simulation sub-process 130 generally begins with petroleum systems modeling at block 132 where maps are generated of various parameters affecting hydrocarbon generation and production. Specifically, risk parameters that are relevant to total gas potential (total reserves) and production potential are plotted in maps at block 132. For example, total gas potential is a combination of free gas and adsorbed gas, while several other risk parameters related to gas production (e.g., porosity, depth, etc.) may also be plotted in maps.

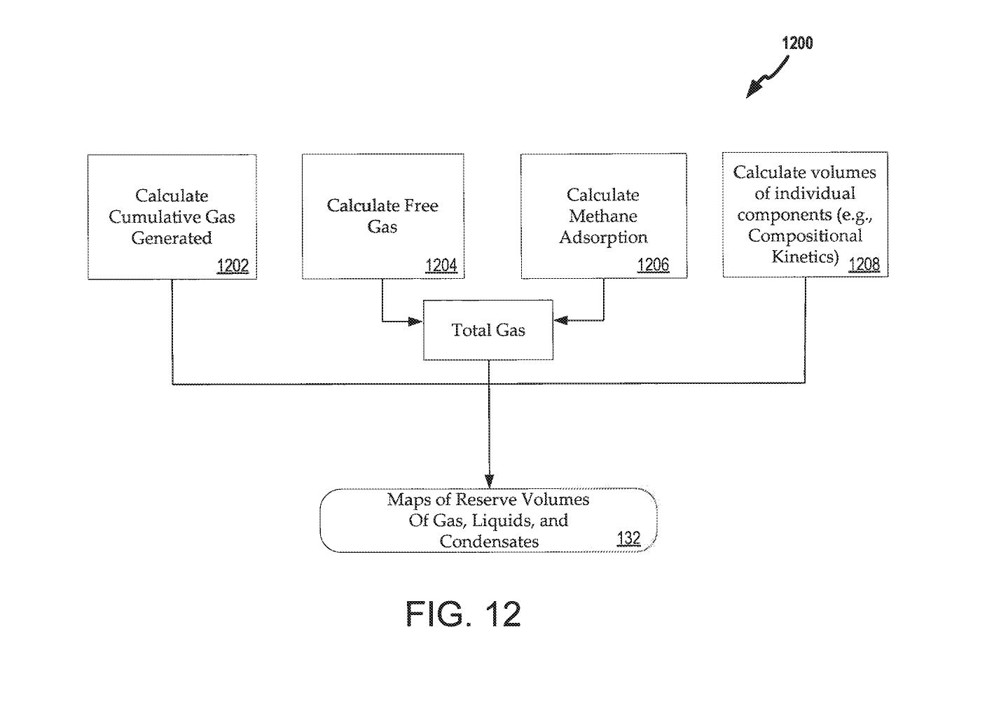

FIG. 12 illustrates a process flow 1200 that may be used to create the maps of block 132. In process flow 1200, cumulative gas generated is calculated using a kinetic model at block 1202. For example, free gas and total gas may be calculated. At block 1204, the amount of free gas in the source/reservoir today is calculated.

At block 1206, methane adsorption may be calculated. In one embodiment, methane adsorption is calculated using laboratory derived Langmuir isotherms that measure the storage capacity of the reservoir under conditions of constant temperature and varying pressure. At block 1108, volumes of individual components (e.g., oil, gas, etc.) may be calculated (e.g., C₂, C₃, C₄, etc.). The maps generated at block 132 provide maps of generated hydrocarbons and gas reserves over the basin.

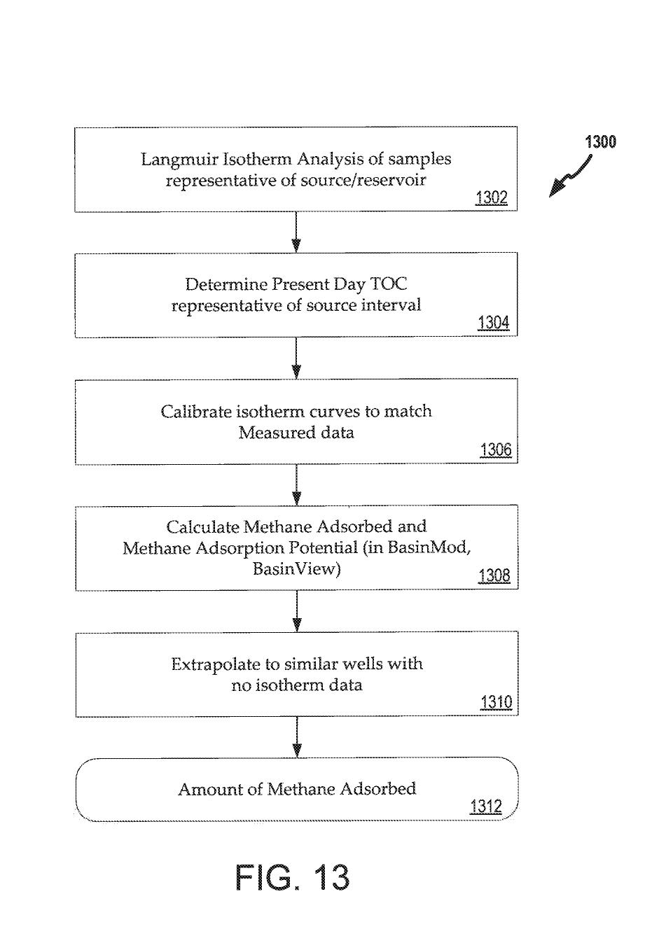

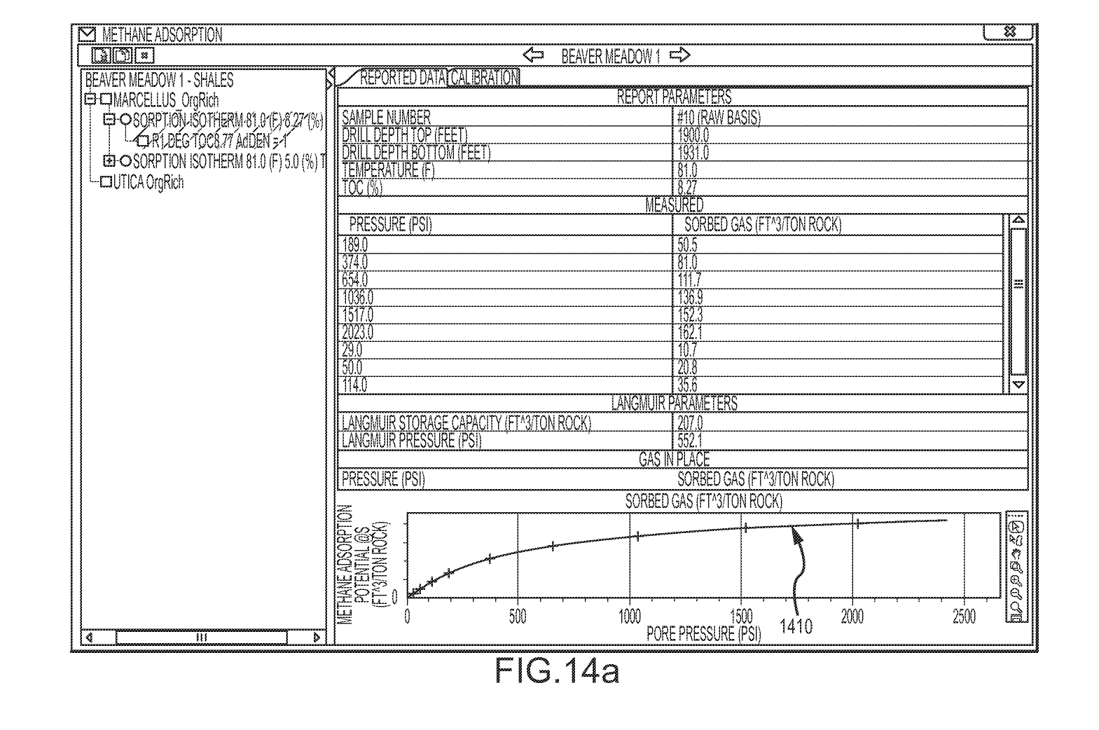

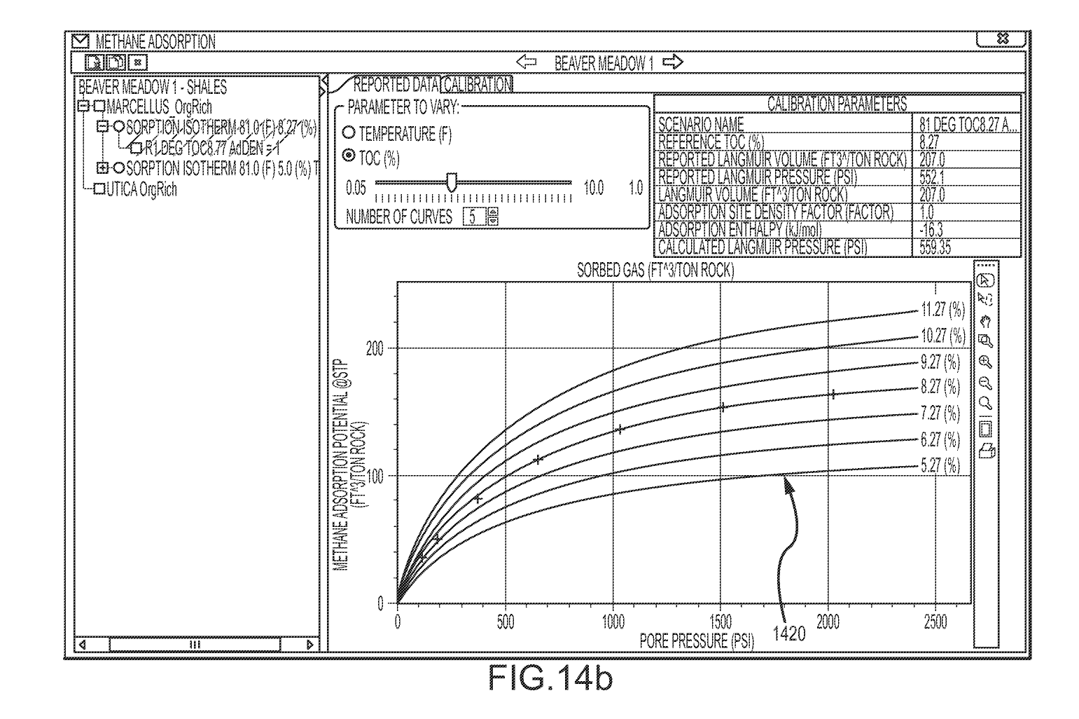

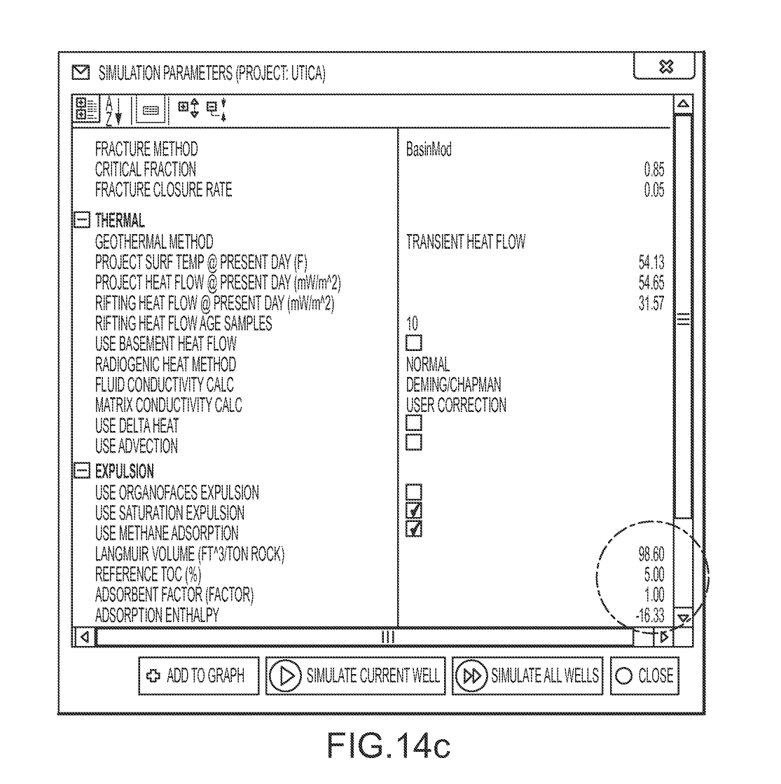

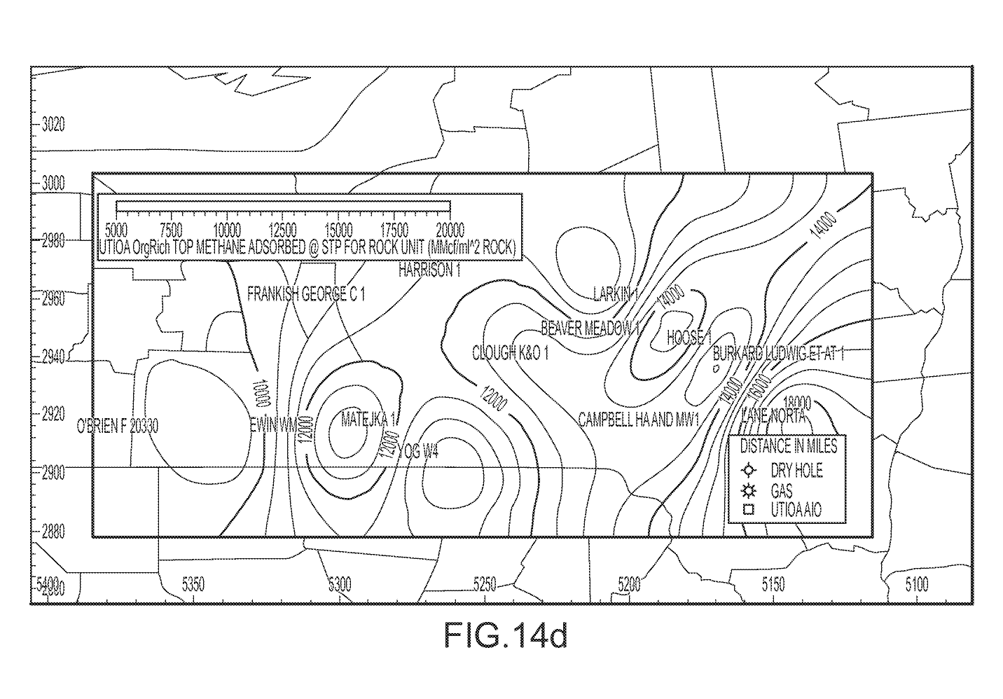

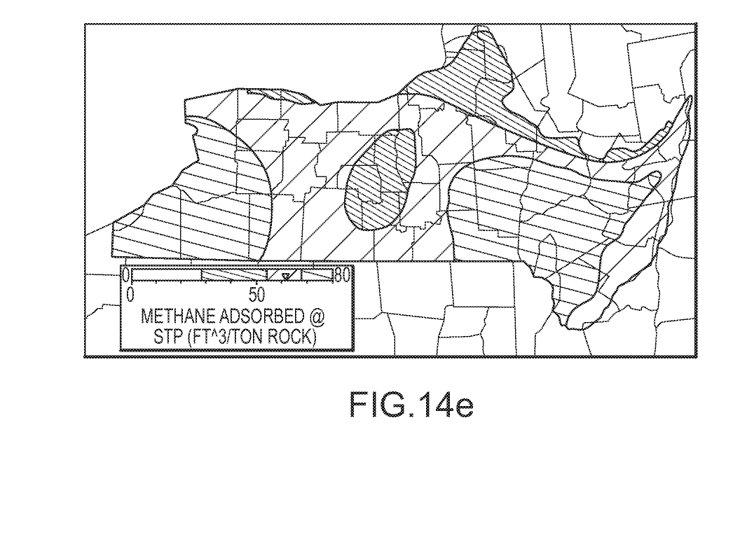

One parameter that may have particular significance in a shale gas play is adsorbed methane. FIG. 13 illustrates calculation of adsorbed methane in more detail, according to various embodiments. In process flow 1300, the amount of adsorbed methane is calculated as a function of pressure, temperature, and the amount of TOC. Process flow 1300 begins at block 1302 with Langmuir isotherm analysis of samples, which is a known analytical technique in the industry. At block 1304 present-day source rock TOC is determined. From the data generated at these steps, Langmuir isotherm curves are calibrated to match the measured data at block 1306. For example, FIG. 14a illustrates an isotherm curve *1410 for adsorption potential vs. Pressure while FIG. 14b illustrates curves *1420 for adsorption potential vs. Pressure at various levels of TOC. These curves may be combined to show adsorption potential vs. pressure for the resource play. With respect to FIG. 14a, the data to be entered under the “Reported Data” tab are from a Langmuir Isotherm analysis (i.e., data obtained from the lab). The pressure data is usually presented in both PSI and MPa and the Storage Capacity Data (=Sorbed Gas) is presented as SCF/ton or m3/tonne. In this example, there are two Methane Adsorption scenarios for the Marcellus source rock. This report shows a sample with TOC=5% taken at a depth of ˜1860 feet and a temperature of 81° F. The Langmuir Storage Capacity and Langmuir Pressure values come directly from the lab report. With respect to FIG. 14b, it shows what is displayed if the Calibration Tab is selected. After the Langmuir Isotherm curve data for each Reference TOC is entered as different scenarios, the user calibrates the scenario by adjusting the Adsorption Site Density factor and an Adsorption Enthalpy value until the calculated Langmuir Pressure agrees with the Langmuir Pressure from the Langmuir analysis and the isotherm shows a good fit with the measured data.

Once methane adsorption has been calibrated, it may be applied to a portion of the resource play that has similar geology and shale composition. The values derived from the calibration can be entered into the Simulation Parameters window as shown in FIG. 14c and used to calculate methane adsorption for the other wells in the play. The modeling results are shown in FIGS. 14d and 14e. FIG. 14d shows methane adsorption values calculated for specific locations (Methane Adsorbed @ STP (MMcf/mi2 rock) and FIG. 14e shows a map of methane storage capacity values (Methane Adsorbed @ STP (ft̂3/ton rock).

Returning now to FIG. 13, at block 1308, the Langmuir analysis results in calculations of methane adsorbed and methane absorption potential. For example, TOC calculations and temperature measurements may be used to calculate and plot methane adsorption potential (STP scf/ton) for the basin. Calculating methane adsorption potential may include extrapolating TOC and/or temperature data to similar wells with no measured data (e.g., isotherm data) at block 1310. Process flow 1300 results in calculation of adsorbed methane across the resource play scope at block 1312, such as is shown in FIGS. 14a and 14b.

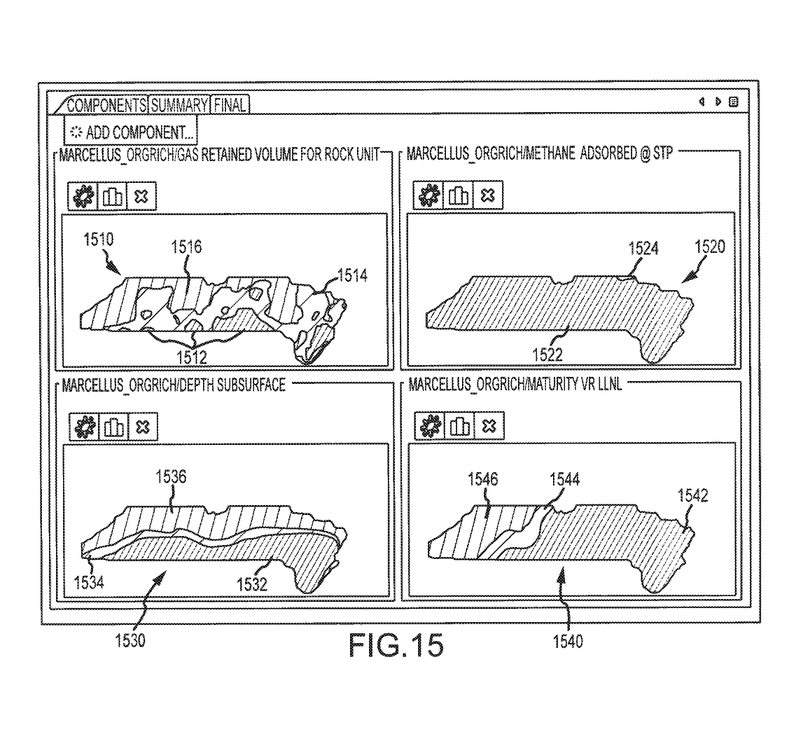

Common Risk Segment (CRS) maps may be generated for several hydrocarbon generation and production parameters and rolled-up to indicate a geologic sweet spot in the shale gas play. FIG. 15 illustrates four different CRS maps plotted for a basin for four different hydrocarbon generation parameters, respectively, according to various embodiments. The plots illustrated in FIG. 15 may illustrate, for example, CRS maps that show low risk areas for various hydrocarbon generation and production parameters. Typically, CRS maps would have regions that are red (high risk), regions that are yellow (medium risk), and regions that are green (low risk) (together, these three colors are the colors used in stoplights) to indicate the different levels of risk associated with attempting to produce oil and gas in those regions. In order to avoid using color drawings in this patent application, the different regions of the CRS maps illustrated herein are shown in different types of shading. It should be understood, however, that this disclosure should be considered to include other types of CRS maps, including those illustrated in color as described above. Map 1510 shows the Gas Retained Volume for a particular geographic region and shaded areas 1512 show the geographic areas with relatively low risk with regard to this parameter, shaded areas 1514 show the geographic areas with relatively medium risk with regard to this parameter, and shaded areas 1516 show the geographic areas with relatively high risk with regard to this parameter. Map 1520 shows Methane Adsorbed for a particular geographic region and shaded areas 1522 show the geographic areas with relatively low risk with regard to this parameter and shaded areas 1524 show the geographic areas with relatively medium risk with regard to this parameter (there are no areas with relatively high risk with regard to this parameter). Map 1530 shows Depth Subsurface for a particular geographic region and shaded areas 1532 show the geographic areas with relatively low risk with regard to this parameter, shaded areas 1534 show the geographic areas with relatively medium risk with regard to this parameter, and shaded areas 1536 show the geographic areas with relatively high risk with regard to this parameter. Map 1540 shows Maturity for a particular geographic region and shaded areas 1542 show the geographic areas with relatively low risk with regard to this parameter, shaded areas 1514 show the geographic areas with relatively medium risk with regard to this parameter, and shaded areas 1516 show the geographic areas with relatively high risk with regard to this parameter.

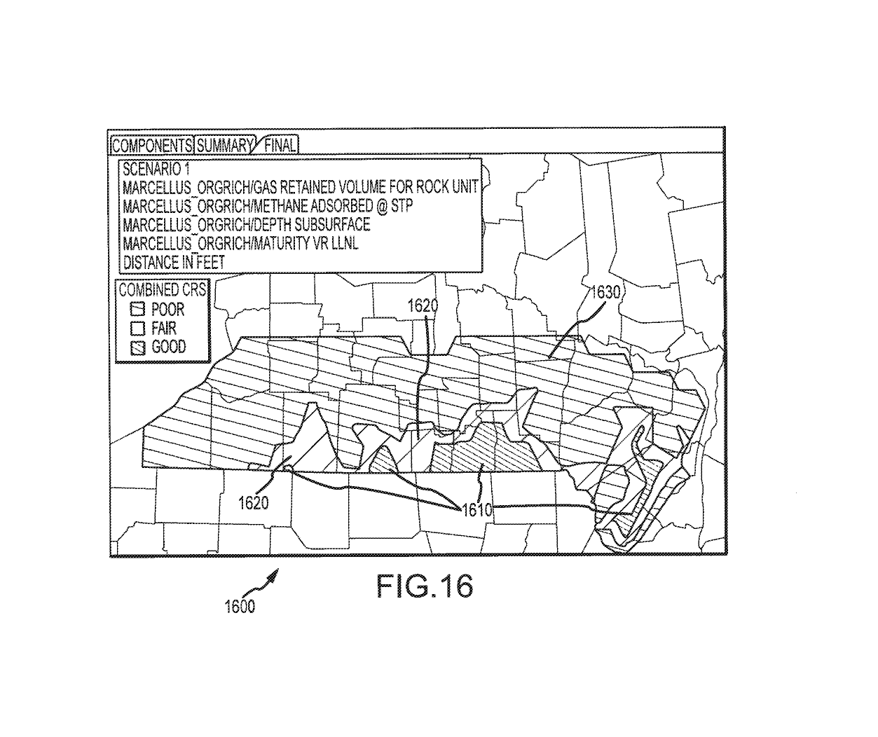

To generate a geologic sweet spot for the play, the CRS maps 1510, 1520, 1530, and 1540 of FIG. 15 may be rolled-up into a composite CRS map. For example, FIG. 16 illustrates a composite CRS map 1600 that combines uncertainty (risk) for multiple layers to derive spatial uncertainty for the area of evaluation. The layers may represent the value and extent of one or more resource play elements. That is, the region 1610 of composite CRS map 1600 may indicate the area of favorable conditions (low risk) for the one or more resource play elements identified in FIG. 15. In one embodiment, region 1610 is generated by evaluating the intersection of the areas of low risk 1512, 1522, 1532, and 1542 (where the uncertainty associated with the play element is less than a predetermined threshold risk) of each play element identified in FIG. 15. Thus, the region 1610 is the region where a resource play would be of relatively low risk for each of the parameters mapped in FIG. 15. The region 1620 is the region other than region 1610 where a resource play would be of relatively low or medium risk for each of the parameters mapped in FIG. 15. The region 1630 is the region where a resource play would be of relatively high risk for at least one of the parameters mapped in FIG. 15.

Returning to sub-process 130, blocks 135, 136, 137, and 138 generally define a process for taking the results of petroleum systems modeling and performing additional calculations involving reservoir engineering data to simulate production parameters and generate production calculations and uncertainty information for a portfolio of well sites within the shale gas play.

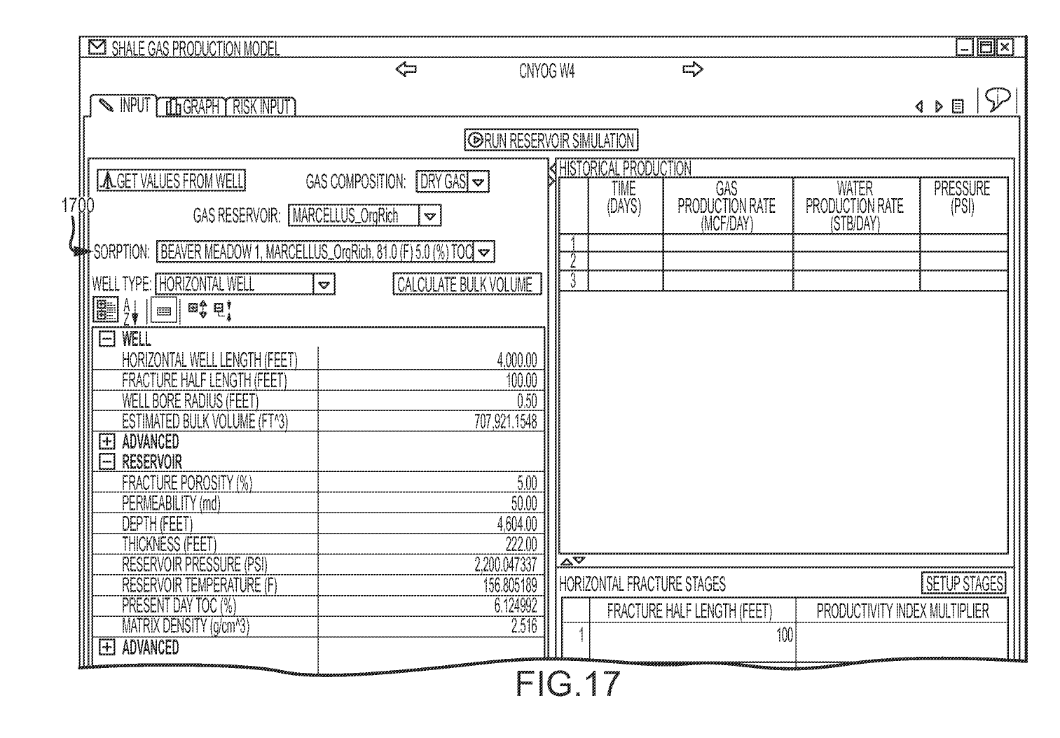

FIG. 17 shows an input screen 1700 for the Shale Gas Production Model. The data under the Well heading and the first two pieces and last piece of data under the Reservoir heading are all input by the user. The remaining data comes from the Basin Petroleum Systems model.

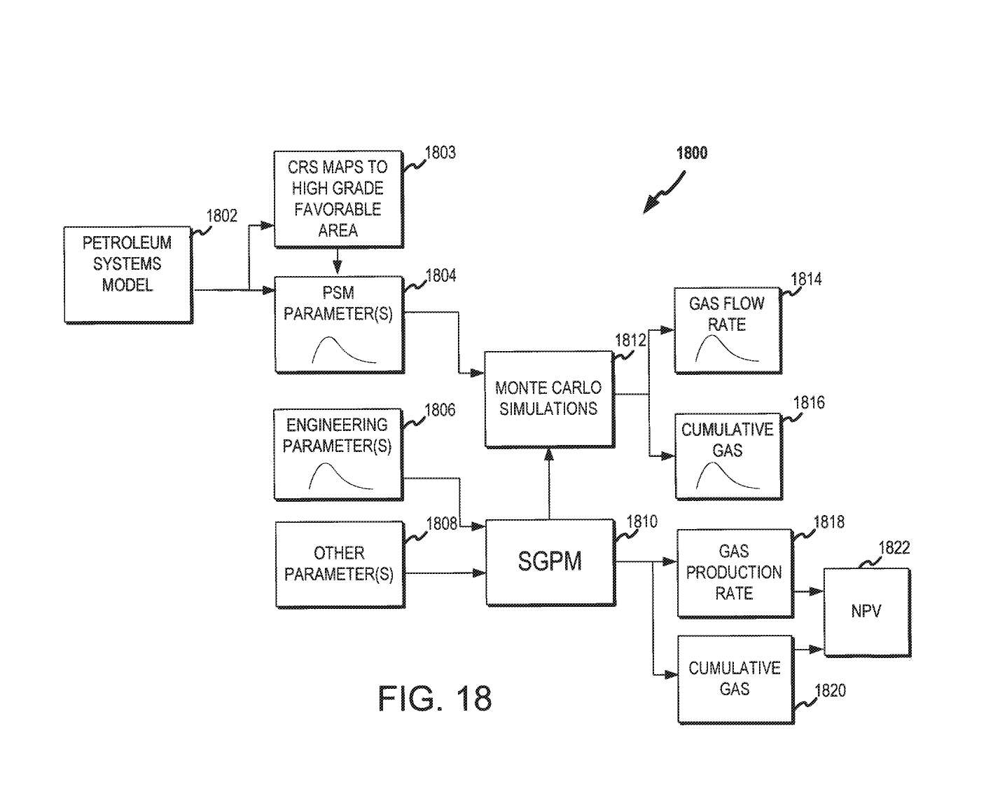

FIG. 18 illustrates a process flow 1800 for calculating uncertainty in production values of a target well site using petroleum systems modeling and reservoir simulation, according to various embodiments. Process flow 1800 combines parameters from petroleum systems modeling with reservoir parameters, a shale gas production model (i.e., reservoir simulator), and/or other project parameters using statistical analysis including Monte Carlo simulation. More particularly, reservoirs in the area of highest resource potential identified at block 132 of sub-process 130 are evaluated and the most prospective sites are selected. Reservoir engineering data for the selected sites are obtained, and the shale gas production model is run on these prospective wells using probability distributions of input parameters including the well parameters and petroleum systems model parameters.

Initially, block 1802 indicates that the production model receives source rock and reservoir properties as user input, with some data coming from petroleum systems modeling. For example, the petroleum systems modeling indicated by block 1802 may include processes and/or calculations described above to calculate petroleum systems model values for the target well site. Petroleum systems model parameters used in process flow 1800 may include source rock depth (ft.), thickness of organic rich interval (ft), reservoir pressure (PSI), reservoir temperature (F/C), TOC (%), Langmuir volume (SCF/ft³), Langmuir pressure (PSI), desorption pressure (PSI), and/or other petroleum systems model parameters. The Langmuir Volume and Langmuir Pressure come from lab analysis. They are not derived, but they may be extrapolated from another well. Block 1803 refers to the CRS maps that may be created for these various parameters.

Block 1804 indicates that various reservoir parameters are selected for Monte Carlo analysis. That is, parameters for which uncertainty in the parameter can affect well production are selected to be varied using Monte Carlo analysis for iterative simulations in the shale gas production model. These parameters may be selected based on various techniques including rank correlation coefficients between the parameters and well production output parameters. For these parameters, probability distributions are selected for the parameters based on the type of parameter. For example, probability distributions such as normal, lognormal, triangular, uniform, and/or beta-PERT may be used to generate probability distributions of petroleum systems model parameters. Factors that may be used to define the probability distributions for these parameters include mean, median, minimum, maximum, most likely, and other distribution factors. In one embodiment, beta-PERT distributions are generated for Monte Carlo simulations of the well production model based on minimum, maximum, and most likely values 1804.

Block 1806 indicates engineering and/or physical parameters that are specific to the target well and/or target site. For example, these values may be supplied by the petrophysicist or the reservoir engineer for a specific proposed well topology and site location. Well parameters may include fracture half length (ft.), well bore radius (ft.), estimated bulk volume (ft³), fracture porosity (%), permeability (md), initial water saturation (fraction), connate water saturation (fraction), residual gas saturation (fraction), and/or other well parameters. One or more of the well parameters may also be varied according to probability distributions for the iterative simulations of the shale gas production model. Input distributions for one or more of these parameters may also be generated for input to the production model according to various probability distributions, in one embodiment, beta-PERT input distributions are generated for various well parameters based on minimum, most-likely, and maximum values provided by the reservoir engineer.

Process flow 1800 may also use other parameters relevant to the well topology, source rock, and/or hydraulic fracturing process. These parameters are received at block 1808 and may include drainage radius (ft.), flowing bottom hole pressure (PSI), vertical permeability (md), pore compressibility (1/psi), water compressibility (1/psi), water end point, water density (lbm/ft³), water exponent, water viscosity (cP), water formation volume factor, gas end point, gas exponent, gas gravity, critical pressure (psi), critical temperature (PC), and/or diffusion coefficient (ft²/day). These parameters may be defined for the target site or the entire resource play project.

Process flow 1800 may use a variety of shale gas production models 1810. For example, a commercial, custom, or semi-custom shale gas production model may be used. Shale gas production models may commonly be provided by a drilling engineering consultant to the resource play project.

At block 1812, process flow 1800 performs iterative Monte Carlo simulations to produce cumulative probability plots of well production parameters. Block 1812 accepts various simulation parameters for well production simulation such as simulated production time (e.g., number of days in gas production simulations, etc.) and delta step (e.g., days, etc.). In addition, block 1812 accepts Monte Carlo simulation parameters such as simulation tolerance and maximum iterations. In one embodiment, the Monte Carlo simulations of block 1812 generate cumulative probability of gas flow rate 1814 and/or cumulative probability of cumulative gas 1816 as illustrated in FIG. 18. However, the Monte Carlo simulations of block 1812 may generate probability distribution of other well production parameters. The Shale Gas Petroleum Model 1810 may also be used to generate Gas Production Rate 1818 and Cumulative Gas 1820, which in turn can be used to determine Net Present Value 1822.

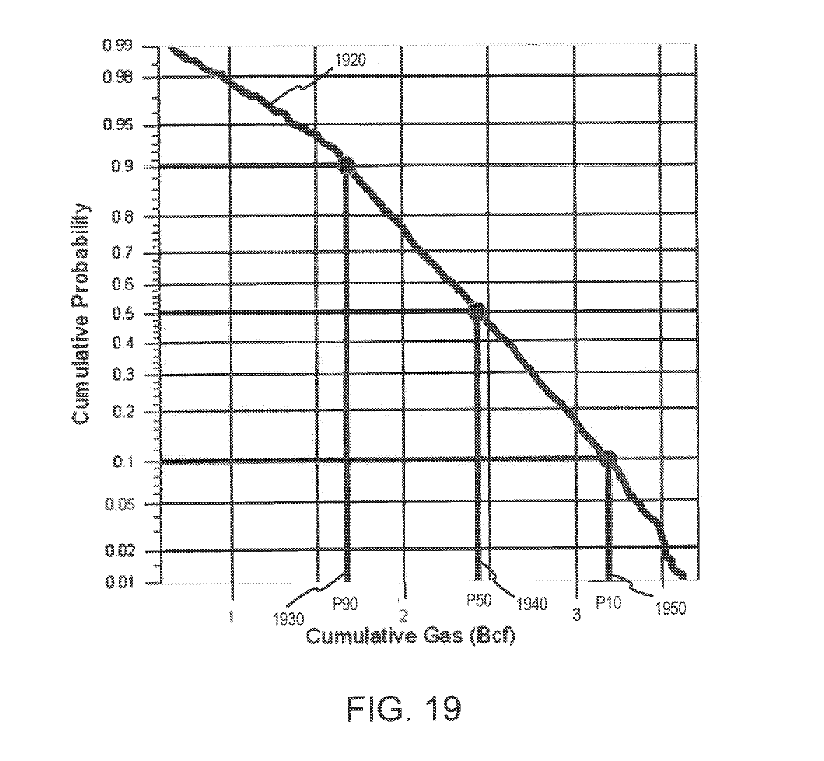

FIG. 19 shows an example of an output probability distribution of a well production parameter, according to various embodiments. For example, FIG. 19 may illustrate a plot of cumulative probability of cumulative gas generated at block 1814 of process flow 1800 for a targeted well site. That is, the iterative simulations of block 1812 produce a probability distribution 1920 of cumulative gas for the targeted well site. From the well production probability distribution 1920, the estimated hydrocarbon reserves may be categorized by uncertainty of hydrocarbon production under current economic conditions using current technology. For example, the hydrocarbon reserves may be categorized by proven reserves (e.g., 90% certainty of production or “P90”), probable reserves (e.g., 50% certainty of production or “P50”), and/or possible reserves (e.g., 10% certainty of production or “P10”). These category points are plotted in FIG. 19 as proven reserves 1930, probable reserves 1940, and possible reserves 1950 for the targeted well site.

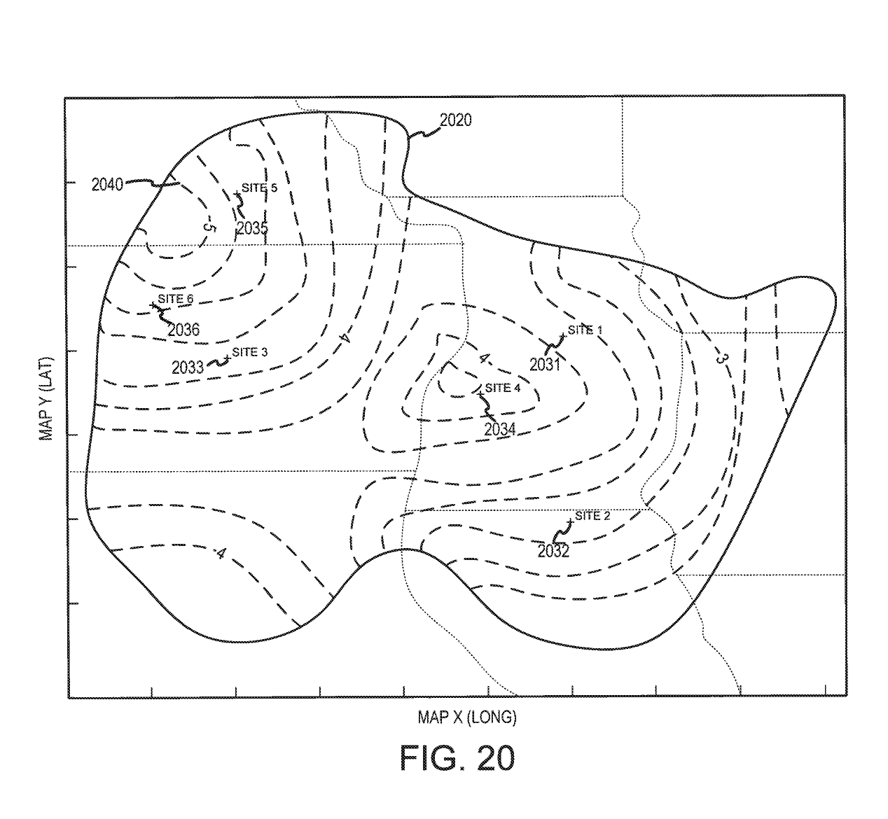

Probability distributions may be extrapolated from sites to provide a map of cumulative probability over a selected area within the basin (e.g., over the “sweet-spot” identified in FIG. 16). For example, FIG. 20 illustrates a plot of probable reserves or P50 for an area outlined by plot line 2020 identified as favorable for resource production during process steps described above. In FIG. 20, target and/or existing well sites 2031, 2032, 2033, 2034, 2035, and/or 2036 are plotted. In addition, contour lines resulting from P50 uncertainty of cumulative gas are plotted to show areas that could be targeted based on cumulative gas uncertainty calculations. For example, contour line 1940 indicates the isoline of 50% probability of 5 BCF cumulative gas. Uncertainty plots of hydrocarbon production parameters may indicate areas of heightened interest within the play, for example, those areas having a concentration of targeted sites with favorable hydrocarbon production parameter distributions.

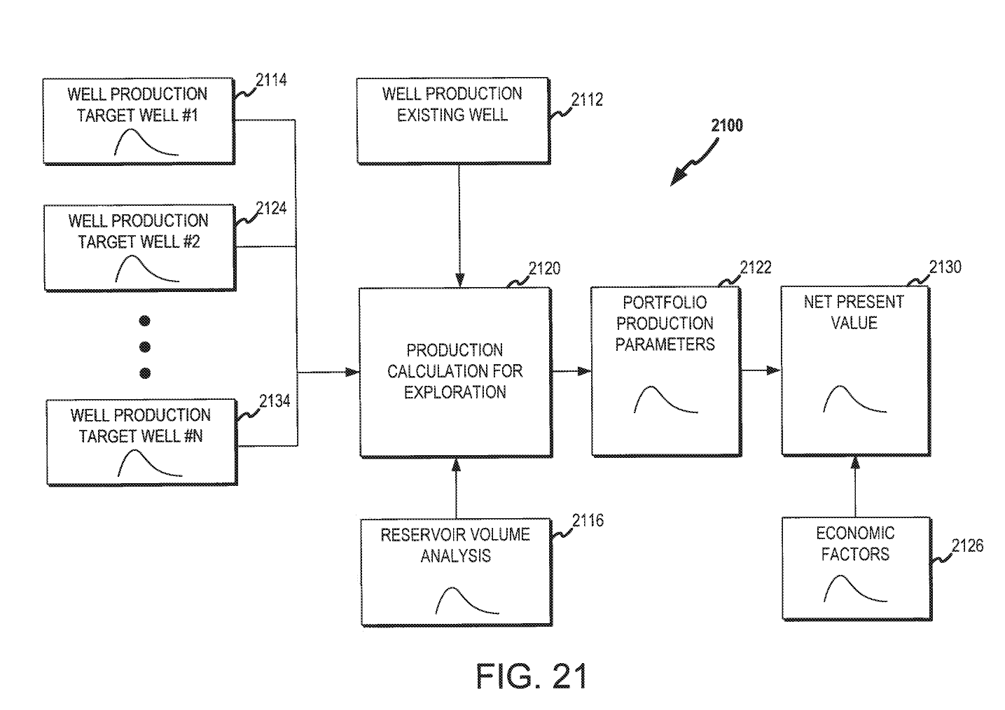

As described above, petroleum systems modeling and simulation sub-process 130 combines petroleum systems modeling and reservoir engineering with economic factors and can provide an economic analysis (e.g., distribution of net present value, etc.) for a resource play portfolio. FIG. 21 illustrates process flow 2100 that may be used to generate production estimates of a well portfolio of targeted sites within a resource play accounting for economic factors, according to various embodiments. Process flow 2100 may use input data from Monte Carlo analysis of targeted sites, existing well production data, reservoir volume analysis, and/or economic factors to provide net present value of the portfolio. Blocks 2114, 2124, and/or 2134 indicate that process flow 2100 may use probability distributions associated with well production of targeted sites within the resource play. For example, these probability distributions may have been generated using process flow 1800 for targeted well sites within the portfolio. Block 2116 indicates that probability distributions associated with reservoir volume analysis may also be used by process flow 2100. For example, various petroleum systems model parameters may be used to calculate factors that affect reservoir volume properties. Probability distributions for these factors may be calculated using Monte Carlo analysis. In one embodiment, probability distribution for hydrocarbon volume factors for the reservoir including gas formation volume factor and/or water formation volume are calculated using input probability distributions for estimated bulk volume and reservoir thickness.

Existing well production may be accounted for as indicated by block 2112. That is, production data from existing wells may be used to calibrate production calculations for targeted wells. More particularly, type-curve matching (or history matching) may be used to correlate results of currently producing wells to wells being modeled with the production simulation model. For example, type-curve matching may be used to modify the input distributions (e.g., minimum, most likely, and/or maximum values for input distributions) for the shale gas production model simulations of process 1800.

Block 2120 indicates production calculation for exploration that takes into account the above factors and parameters. Production calculation for exploration block 2120 accepts input parameters and input parameter distributions as described above, and calculates a probability distribution of portfolio production parameters 2122 of the well portfolio. Production calculation for exploration block 2120 may calculate several production probability distributions. For example, portfolio production parameters may include parameters such as average gas flow rate, pressure decline rate, gas in-place volume, gas recoverable reserves, and/or free/adsorbed gas recovery factor.

The portfolio production probability distributions are analyzed at block 2130 using economic factors 2126 to provide net present value of the recoverable resources of the portfolio. For example, economic factors that may be used at block 2130 include current and/or predicted gas prices, interest rates, cost of capital, transportation costs associated with getting gas to market from the targeted sites, site costs (e.g., leasing, etc.), regulatory costs, environmental costs (e.g., compliance, containment, etc.), and/or other economic factors. If costs have not been estimated for a specific well, the user can base cost estimates on adjacent similar wells. Accordingly, net present value for the portfolio provides uncertainty risking for the well portfolio. Based on the results, one or more portfolio parameters may be adjusted and the analysis re-run to determine the effect on net present value determined at block 2130. In this way, the resource play may be evaluated accounting for petroleum systems analysis, reservoir engineering, and/or economic factors to produce an uncertainty profile associated with the targeted sites and/or well portfolio.

The foregoing description has been presented for purposes of illustration and description. Furthermore, the description is not intended to limit embodiments of the invention to the form disclosed herein. While a number of exemplary aspects and embodiments have been discussed above, those of skill in the art will recognize certain variations, modifications, permutations, additions, and sub-combinations thereof.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

The various illustrative logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure, may be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The functions described may be implemented in hardware, software, firmware, or any combination thereof. If implemented in software, the functions may be stored as one or more instructions on a tangible computer-readable medium. A storage medium may be any available tangible medium that can be accessed by a computer. By way of example, and not limitation, such computer-readable media can comprise RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material.

Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Further, modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A method, comprising:
identifying a targeted reserves region for producing oil and/or gas, based on one or more parameters relating to a source rock associated with the oil and/or gas and/or relating to a reservoir associated with the oil and/or gas;
selecting one or more targeted well sites within the targeted reserves region based on uncertainty associated with parameters that are related to oil and gas potential; and
modeling well production for one or more of the targeted well sites based on one or more of the source rock parameters, reservoir parameters, or oil and gas potential parameters.

2. The method of claim 1, further including calculating a cumulative probability of a well production parameter for the one or more targeted well sites based on aggregated results from iterative simulations of a well production simulation model, wherein at least one simulation input parameter to the well production simulation model is varied over the iterative simulations based on an input probability distribution.

3. The method of claim 2, wherein at least one factor of the input probability distribution for the at least one simulation input parameter is generated using a petroleum systems model.

4. The method of claim 4, wherein the at least one factor of the input probability distribution for the at least one simulation input parameter includes a most likely value of the at least one simulation input parameter at the targeted well site.

5. The method of claim 2, wherein the at least one simulation input parameter is based at least in part on a calculation of methane adsorption potential for the basin.

6. The method of claim 2, wherein at least one factor of the input probability distribution for the at least one simulation input parameter is specific to one of the one or more targeted well sites.

7. The method of claim 2, further including calculating a cumulative probability of a net present value parameter of a shale gas well portfolio including the one or more targeted well sites by aggregating results from iterative well portfolio simulations, wherein at least one portfolio input parameter of the iterative well portfolio simulations is varied according to a well production probability distribution generated from the iterative simulations of the well production simulation model.

8. The method of claim 8, wherein well production data from a producing well in the Shale gas well portfolio is compared to a well production simulation of the producing well, and wherein at least one simulation input parameter of the iterative well production simulations is modified based on a result of the comparison.

9. The method of claim 2, wherein the at least one simulation input parameter is selected based on a rank correlation between the simulation input parameter and a well production parameter output of the shale gas production model.

10. The method of claim 2, further including calculating a cumulative probability of a well production parameter across a geographical portfolio region based on the calculated cumulative probability of the well production parameter for a plurality of the targeted well sites.

11. The method of claim 1, wherein the identifying and selecting includes generating a plurality of common risk segment maps for an identified hydrocarbon basin, each common risk segment map indicating an estimated risk for a hydrocarbon production factor by geographical location within the identified hydrocarbon basin; and
generating a composite common risk segment map based on the plurality of common risk segment maps, the composite common risk segment map indicating a targeted reserves region for which one or more of the plurality of common risk segment maps indicates a risk profile with lower than a predetermined risk.

12. The method of claim 11, wherein at least one of the common risk segment maps includes a map of a generated gas property, the generated gas property based on a kinetic modeling process.

13. The method of claim 11, wherein at least one of the common risk segment maps includes a map of adsorbed gas, and wherein the map of adsorbed gas is calculated based on a Langmuir analysis.

14. A method for identifying an economically viable geographic area for shale gas production within a basin, the method comprising:
calculating a total organic content of source rock within the basin by geographical location;
determining a type of organic matter present in the source rock within the basin by geographical location;
calculating a thermal maturity of organic matter within the basin by geographical location; and
calculating a graded effectiveness of source rock within the basin by geographical location based on the total organic content, the organic matter type, and the thermal maturity of the organic matter within the basin.

15. The method of claim 14, wherein calculating the total organic content includes calculating an organic rich interval of source rock.

16. The method of claim 15, wherein calculating the organic rich interval of source rock within the basin is based at least in part on a sequence stratigraphy of the basin.

17. The method of claim 15, wherein calculating the organic rich interval of source rock within the basin is based at least in part on identification of a transgressive systems tract using sequence stratigraphy.

18. The method of claim 17, wherein the identified transgressive systems tract is correlated to a measured organically rich interval.

19. A method comprising:
calculating at least one source rock composition property over a geographic area;
calculating at least one reservoir porosity property of a hydrocarbon basin by geographic location;
calculating at least one reservoir pressure property of a hydrocarbon basin by geographic location; and
generating a reservoir effectiveness map based on the at least one source rock property, the at least one hydrocarbon flow property, and the at least one reservoir pressure property, the reservoir effectiveness map indicating areas of favorable reservoir production performance over the geographic area.

20. The method of claim 19, wherein the at least one reservoir porosity property is based at least in part on a nanoporosity parameter associated with degradation of organic carbon within the basin.

21. The method of claim 19, wherein the at least one reservoir pressure property is based at least in part on a reservoir pressure component associated with uplift of source rock in the geographic area.

22. The method of claim 19, wherein the at least one reservoir pressure property is based at least in part on a calculated generation pressure associated with conversion of organic matter to hydrocarbons within the reservoir.

23. The method of claim 19, wherein reservoir pressure is based on at least one of the following reservoir pressure components: mechanical compaction, chemical compaction, generation pressure, and/or pressure associated with the development of nanoporosity due to degradation of organic carbon and gas expansion within the nanoporosity due to uplift of the source rock.
